(19) United States
(12) Patent Application Publication
(10) Pub. No.: US 2026/0288036 A1
(43) Pub. Date: Sep. 24, 2026

(54) IMAGE FORMING APPARATUS

(71) Applicant: KYOCERA Document Solutions Inc., Osaka (JP)

(72) Inventors: Minoru WADA, Osaka (JP); Kohei TERASAKI, Osaka (JP); Norio KUBO, Osaka (JP)

(73) Assignee: KYOCERA Document Solutions Inc., Osaka (JP)

(21) Appl. No.: 19/569,774

(22) Filed: Mar. 17, 2026

(30) Foreign Application Priority Data
Mar. 24, 2025 (JP) 2025-048534

(51) Int. Cl. G03G 15/09; G03G 9/107; G03G 9/113

(52) U.S. Cl. CPC G03G 15/0921; G03G 9/108; G03G 9/1136; G03G 2215/0609

(57) ABSTRACT

When a surface potential of an opposing member is Vop (V), a DC voltage is Vdv (V), a particle size of carrier is Dc (m), a thickness of a coat layer is Tc (m), a space between a first surface and a second surface is Dg (m), and a maximum electric field applied to the coat layer is Emax (V/m), which is expressed by the following equation (1), then the following inequality (2) is satisfied.

$$Emax = \vert Vop - Vdv \vert \times Dc / ( Tc \times 2 \times Dg ) \qquad ( 1 )$$

$$Emax \leq 4. \times 1 {0}^{7} \qquad ( 2 )$$

### INCORPORATION BY REFERENCE

This application is based upon and claims the benefit of priority from the corresponding Japanese Patent Application No. 2025-048534 filed Mar. 24, 2025, the entire contents of which are hereby incorporated by reference.

### BACKGROUND

The present disclosure relates to an image forming apparatus.

Conventionally, it is known that in an image forming apparatus using a two-component developer, image quality is affected by an electric field or carrier physical properties in a developing unit. For instance, conventionally, carrier resistance at a maximum electric field in the developing unit is prescribed, so as to suppress image missing due to carrier development caused by dielectric breakdown of the carrier.

### SUMMARY

An image forming apparatus according to a first aspect of the present disclosure includes a developer carrying member and an opposing member. The developer carrying member has a first surface, and carries a magnetic brush on the first surface, the magnetic brush containing toner and carrier in which carrier cores are coated with coat layers. The opposing member has a second surface located to face the first surface, and is applied with a development voltage including a DC voltage, so as to carry the toner moved from the magnetic brush, on the second surface. When a surface potential of the opposing member is Vop (V), the DC voltage is Vdv (V), a particle size of the carrier is Dc (m), a thickness of the coat layer is Tc (m), a space between the first surface and the second surface is Dg (m), and a maximum electric field applied to the coat layer is Emax (V/m), which is expressed by the following equation (1), then the following inequality (2) is satisfied.

$$Emax = \vert Vop - Vdv \vert \times Dc / ( Tc \times 2 \times Dg ) \qquad ( 1 )$$

$$Emax \leq 4. \times 1 {0}^{7} \qquad ( 2 )$$

### BRIEF DESCRIPTION OF THE DRAWINGS

FIG. 1 is a schematic diagram of an image forming apparatus according to an embodiment.

FIG. 2 is a schematic diagram of a developing device and its vicinity according to the embodiment.

FIG. 3 is a schematic diagram of a developer according to the embodiment.

FIG. 4 is a schematic diagram of a magnetic brush and its vicinity, the magnetic brush being carried on a developing roller of the developing device according to the embodiment.

FIG. 5 is a diagram illustrating results of an experiment that was performed for confirming effects of the present disclosure.

### DETAILED DESCRIPTION

### <1. Image Forming Apparatus>

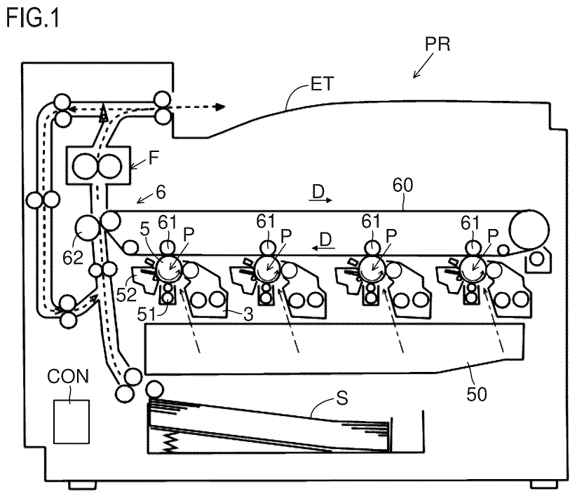

Hereinafter, with reference to FIG. 1, an image forming apparatus PR of this embodiment is described. The image forming apparatus PR is a printer.

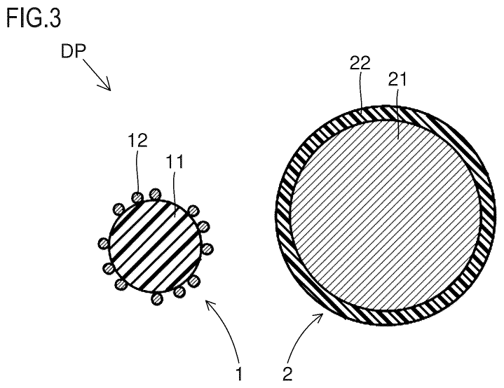

The image forming apparatus PR uses a developer DP (see FIG. 3), so as to perform electrophotographic printing on a sheet S as a recording medium. Note that the developer DP is a two-component developer, which contains toner (an aggregate of toner particles 1) and carrier (an aggregate of carrier particles 2).

The image forming apparatus PR has a conveying path. In FIG. 1, the conveying path is shown by a broken line arrow. The image forming apparatus PR supplies the sheet S stored in a cassette to the conveying path, and conveys the sheet S along the conveying path. In this way, the sheet S passes through a transfer position and a fixing position in this order, and then is discharged onto a discharge tray ET. At the transfer position, a transferring process is performed on the sheet S. At the fixing position, a fixing process is performed on the sheet S.

The image forming apparatus PR includes four image forming units P corresponding to four colors, i.e., cyan, magenta, yellow, and black colors. Each of the image forming units P forms an image using toner of the corresponding color. Hereinafter, one of the image forming units P is noted and a structure thereof is described. The image forming units P have the same basic structure. Therefore, descriptions of structures of other image forming units P are omitted by citing the following description.

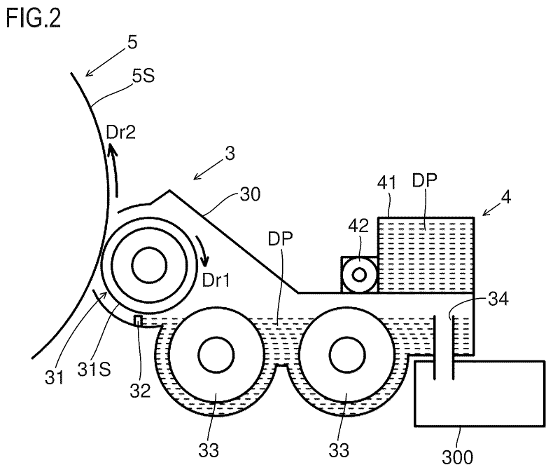

The image forming unit P includes developing device 3. The developing device 3 is connected to a replenishment unit 4 (see FIG. 2). In addition, the image forming unit P includes photosensitive drum 5.

The photosensitive drum 5 has an outer peripheral surface 5S that functions as a toner carrying surface. An electrostatic latent image is formed on the outer peripheral surface 5S of the photosensitive drum 5, and the toner is supplied to the electrostatic latent image. The photosensitive drum 5 carries the supplied toner on the outer peripheral surface 5S. In the following description, the outer peripheral surface 5S of the photosensitive drum 5 is referred to as the drum outer peripheral surface 5S. Note that the photosensitive drum 5 corresponds to an “opposing member”, and the drum outer peripheral surface 5S corresponds to a “second surface”.

The image forming unit P further includes a charging device 51 and a cleaning device 52. The photosensitive drum 5 constitutes one unit together with the charging device 51 and the cleaning device 52. Note that the image forming unit P includes an exposure device 50. The single exposure device 50 is shared by the image forming units P.

When the image forming unit P forms an image, the photosensitive drum 5 rotates. The charging device 51 is applied with a charging voltage from a not-shown charging voltage power supply. The charging device 51 charges the photosensitive drum 5. In this way, the drum outer peripheral surface 5S is charged at a predetermined potential. The exposure device 50 exposes the drum outer peripheral surface 5S, so as to form an electrostatic latent image on the drum outer peripheral surface 5S. The developing device 3 supplies the toner to the electrostatic latent image on the drum outer peripheral surface 5S, so as to develop the electrostatic latent image into a toner image. The replenishment unit 4 replenishes the developer DP to the developing device 3. The cleaning device 52 removes residual toner on the drum outer peripheral surface 5S.

The image forming apparatus PR includes a transfer unit 6. The transfer unit 6 transfers the toner image on the drum outer peripheral surface 5S of each photosensitive drum 5 to the sheet S. In other words, the transfer unit 6 transfers the images developed by the developing devices 3 to the sheet S.

The transfer unit 6 includes an intermediate transfer belt 60. The intermediate transfer belt 60 is an endless belt. The intermediate transfer belt 60 contacts the drum outer peripheral surface 5S of each photosensitive drum 5, and in this state, moves (rotates) in the direction shown by an arrow D.

The transfer unit 6 includes primary transfer rollers 61. There are a plurality of the primary transfer rollers 61 each of which is allotted to each of the cyan, magenta, yellow, and black colors. The primary transfer rollers 61 are disposed on an inner peripheral side of the intermediate transfer belt 60. Each of the primary transfer rollers 61 is disposed to face the drum outer peripheral surface 5S of the photosensitive drum 5 carrying the toner image of the corresponding color, via the intermediate transfer belt 60 between them.

In addition, the image forming apparatus PR includes one secondary transfer roller 62. The secondary transfer roller 62 is pressed to contact the outer peripheral surface of the intermediate transfer belt 60 at the transfer position. A transfer nip is formed between the secondary transfer roller 62 and the intermediate transfer belt 60. In other words, the transfer nip is formed at the transfer position.

In a print job, the sheet S is conveyed to the transfer position (i.e., the transfer nip). The sheet S that is being conveyed passes through the transfer nip.

The intermediate transfer belt 60 receives primary transfer of toner images from the photosensitive drums 5. The intermediate transfer belt 60 rotates while carrying the toner images on the outer peripheral surface. When the sheet S is passing through the transfer nip, the sheet S contacts the outer peripheral surface of the intermediate transfer belt 60. In this way, the toner images are secondarily transferred to the sheet S that is passing through the transfer nip.

The image forming apparatus PR includes a fixing unit F. The fixing unit F includes a heating roller and a pressure roller. The heating roller includes a heater inside. The pressure roller is pressed to contact the heating roller. The heating roller and the pressure roller contact each other with pressure so as to form a fixing nip at the fixing position.

In the print job, the sheet S after the transferring process passes through the fixing nip. In other words, the sheet S is sandwiched between the heating roller and the pressure roller at the fixing nip. The fixing unit F heats the sheet S that is passing through the fixing nip. At the fixing nip, the sheet S is pressed. The fixing unit F heats and presses the sheet S after the transferring process, so as to fix the toner image to the sheet S. After the fixing process, the sheet S is discharged onto the discharge tray ET.

### <2. Developing Device>

Hereinafter, with reference to FIG. 2, the developing device 3 of this embodiment is described.

The developing device 3 uses the developer DP (see FIG. 3), so as to develop the electrostatic latent image. A development method of the developing device 3 is a trickle development method. The developing device 3 receives replenishment of the developer DP from the replenishment unit 4. In other words, the image forming apparatus PR includes the replenishment units 4 in addition to the developing devices 3. The replenishment unit 4 may be one component of the developing device 3.

The developing device 3 includes a development casing 30. The developer DP is stored in the development casing 30 in advance. The developing device 3 uses the developer DP stored in the development casing 30 so as to perform development. In the following description, the developer DP stored in the development casing 30 is referred to as “developer currently in use”. On the other hand, the developer DP replenished from the replenishment unit 4 into the development casing 30 is referred to as “replenishment developer”.

The developing device 3 includes a developing roller 31. The developing roller 31 has an outer peripheral surface 31S as a developer carrying surface. The developing roller 31 corresponds to a “developer carrying member”, and the outer peripheral surface 31S corresponds to a “first surface”. In the following description, the outer peripheral surface 31S of the developing roller 31 is referred to as the developer carrying surface 31S.

The developing roller 31 is disposed inside the development casing 30 and is supported in a rotatable manner. The developer carrying surface 31S of the developing roller 31 is partially exposed from inside to outside of the development casing 30. Specifically, the development casing 30 has an opening at a position facing the drum outer peripheral surface 5S. From this opening, the developer carrying surface 31S is partially exposed to the outside. In this way, the developer carrying surface 31S and the drum outer peripheral surface 5S face each other.

The developing roller 31 carries the developer currently in use on the developer carrying surface 31S, and supplies the toner in the developer currently in use to the electrostatic latent image on the drum outer peripheral surface 5S. In this case, the developing roller 31 and the photosensitive drum 5 rotate individually. In FIG. 2, a rotation direction of the developing roller 31 is shown by an arrow Dr1, and a rotation direction of the photosensitive drum 5 is shown by an arrow Dr2.

The developing roller 31 includes a sleeve and a magnet roller. The sleeve is supported in a rotatable manner. An outer peripheral surface of the sleeve carries the developer currently in use. The magnet roller is disposed inside the sleeve (inside the cylinder thereof). The magnet roller is supported in a manner unable to rotate. The magnet roller has a plurality of magnetic poles in the circumferential direction. The sleeve can rotate about an axis of the magnet roller.

The developing device 3 includes a regulating blade 32. The regulating blade 32 is attached to the development casing 30. The regulating blade 32 is disposed so that its distal end part is adjacent to the outer peripheral surface of the developing roller 31. A distal end part of the regulating blade 32 is disposed on an upstream side of the facing area between the developing roller 31 and the photosensitive drum 5, in the rotation direction of the developing roller 31.

The developing device 3 includes two stirring screws 33. Each of the stirring screws 33 is disposed inside the development casing 30 and is supported in a rotatable manner. Each of the stirring screws 33 has a structure in which a helical blade is disposed on the rotation shaft. Each of the stirring screws 33 rotates so as to stir and convey the developer currently in use, while the toner in the developer currently in use is charged.

During rotation of the developing roller 31, the developer currently in use (specifically, the carrier carrying the toner) is attracted to the developer carrying surface 31S by a magnetic force of the magnet roller, and a magnetic brush is formed on the developer carrying surface 31S. When the magnetic brush passes through between the developing roller 31 and the regulating blade 32, the magnetic brush is regulated to have a constant layer thickness. Then, the magnetic brush on the developer carrying surface 31S contacts the drum outer peripheral surface 5S.

In addition, the developing roller 31 is applied with a development voltage including a DC voltage from a not-shown development voltage power supply. The development voltage is a voltage in which an AC voltage is superimposed on the DC voltage. When the development voltage is applied between the developing roller 31 and the photosensitive drum 5, a potential difference is generated between the developing roller 31 and the photosensitive drum 5. This potential difference allows the toner in the magnetic brush to move from the developing roller 31 to the photosensitive drum 5. The photosensitive drum 5 carries the toner moved from the magnetic brush on the developer carrying surface 31S, on the drum outer peripheral surface 5S. The toner is supplied to the electrostatic latent image on the drum outer peripheral surface 5S (to parts whose potentials are decreased by exposure). In this way, the electrostatic latent image on the drum outer peripheral surface 5S is developed into the toner image.

The developing device 3 has a discharge path 34. The discharge path 34 connects the inside of the development casing 30 and a collection box 300. In this way, excess developer currently in use flows into the discharge path 34, moves along the discharge path 34, and reaches the collection box 300. In other words, the collection box 300 stores the excess developer currently in use.

The replenishment unit 4 includes a container 41 and a replenishment member 42. The container 41 stores replenishment developer. The replenishment member 42 replenishes the replenishment developer stored in the container 41 to the developing device 3. For instance, the replenishment member 42 includes a screw shaft. When the screw shaft rotates, the replenishment developer is replenished from the container 41 to the inside of the development casing 30.

Note that the image forming apparatus PR includes a controller unit CON (see FIG. 1). The developing device 3 is equipped with a T/C sensor. The T/C sensor is connected to the controller unit CON. The T/C sensor detects a mixing ratio between the toner and the carrier in the developer currently in use. On the basis of an output of the T/C sensor, the controller unit CON controls replenishment of the replenishment developer from the replenishment unit 4 to the developing device 3. In other words, the controller unit CON controls the replenishment member 42 (to rotate and stop the screw shaft).

The T/C sensor is a magnetic permeability sensor and outputs a value corresponding to a magnetic permeability of the developer currently in use. As the ratio of the carrier in the developer currently in use is higher, the magnetic permeability of the developer currently in use is higher. Utilizing this fact, the mixing ratio between the toner and the carrier in the developer currently in use is detected. Further, a toner remaining amount in the developer currently in use can be detected from the detected mixing ratio.

When starting to use the developing device 3, the development casing 30 already stores initial developer inside. The initial developer is the developer DP stored inside the development casing 30 when the image forming apparatus PR is shipped (before a user uses the image forming apparatus PR). In other words, when starting to use the developing device 3, the developer currently in use contains only the initial developer.

After starting use of the developing device 3, when the print job is performed, the developer currently in use is consumed and decreased. In other words, the initial developer is decreased inside the development casing 30. For this reason, after starting use of the developing device 3, the replenishment developer is replenished from the replenishment unit 4 to the developing device 3. The developer DP stored in the container 41 is the replenishment developer.

While the image forming apparatus PR continues the print job, the replenishment developer is replenished into the development casing 30 while the developer currently in use is discharged from the inside of the development casing 30. In this way, inside the development casing 30, the developer currently in use is gradually changed, i.e., the initial developer is gradually replaced by the replenishment developer. In other words, the initial developer and the replenishment developer are mixed as the developer currently in use.

### <3. Developer>

Hereinafter, with reference to FIG. 3, the developer DP of this embodiment is described.

The toner of the developer DP contains the toner particles 1, and the carrier of the developer DP contains the carrier particles 2. The toner is an aggregate of the toner particles 1, and the carrier is an aggregate of the carrier particles 2. FIG. 3 schematically illustrates the single toner particle 1 and the single carrier particle 2.

Note that the developer DP as the initial developer and the developer DP as the replenishment developer may have the same components, mixing ratio between the toner and the carrier, production method, and the like. Alternatively, at least a part of the components, the mixing ratio between the toner and the carrier, the production method, and the like may be different between the developer DP as the initial developer and the developer DP as the replenishment developer.

### <3-1. Toner>

The toner particle 1 has a toner mother particle 11. The toner mother particle 11 is, for example, a non-encapsulated toner mother particle without a shell layer. The toner mother particle 11 may be an encapsulated toner mother particle in which a toner core is coated with a shell layer.

The toner mother particle 11 contains binder resin, for example. As the binder resin, a thermoplastic resin such as polyester resin may be used. The toner mother particle 11 may contain a coloring agent, a charge control agent, a mold release agent, and the like. The toner particle 1 has external additive particles 12. The external additive particles 12 adhere to the surface of the toner mother particle 11. As the external additive particles 12, silica particles, aluminum oxide particles, or the like may be used. In addition, if necessary, resin particles, magnesium oxide particles, zinc oxide particles, or the like may be used as the external additive particles 12.

In the toner particle 1, the contained amount of the silica particles is preferably 0.1 pts. mass or more and 10.0 pts. mass or less, and more preferably 0.4 pts. mass or more and 3.0 pts. mass or less, with respect to 100.0 pts. mass of toner mother particle 11. In addition, the mean primary particle diameter of the silica particle is preferably 10 nm or more and 30 nm or less, and more preferably 15 nm or more and 25 nm or less. The silica particle may be surface treated.

The contained amount of the aluminum oxide particles in the toner particle 1 is preferably 0.05 pts. mass or more and 3.0 pts. mass or less, and more preferably 0.3 pts. mass or more and 1.5 pts. mass or less, with respect to 100.0 pts. mass of toner mother particle 11. In addition, the mean primary particle diameter of the aluminum oxide particle is preferably 200 nm or more and 600 nm or less, and more preferably 300 nm or more and 500 nm or less.

Note that the mean primary particle diameter in this specification is a mean value of equivalent circle diameters of primary particles measured using a scanning electron microscope (a Heywood diameter: a diameter of a circle having the same area as a projected area of the primary particle). The mean primary particle diameter is, for example, a mean value of equivalent circle diameters of 100 primary particles. For measuring the mean primary particle diameter, a field emission type scanning electron microscope (“JSM-7600F” manufactured by Japan Electron Optics Laboratory Co., Ltd.) can be used.

### <3-2. Carrier>

The carrier particle 2 has a carrier core 21. The carrier core 21 contains magnetic material. As the magnetic material, it is possible to use a metal oxide such as ferrite, magnetite, or maghemite. Note that the ferrite has high flowability and chemical stability tendency. For this reason, it is preferred that the carrier core 21 contain ferrite. As an example of the ferrite, there is Ba ferrite, Mn ferrite, Mn—Zn ferrite, Ni—Zn ferrite, Mn—Mg ferrite, Ca—Mg ferrite, Li ferrite, and Cu—Zn ferrite. The shape of the carrier core 21 is not particularly limited, and it may be an irregular shape or a spherical shape.

The carrier core 21 has a saturation magnetization of 75 emu/g or more. Note that in this specification, the saturation magnetization is a value measured using a sensitive vibrating sample magnetometer (“VSM-P7” manufactured by Toei Industry Co., Ltd.) under the condition of an external magnetic field of 3,000 (Oe). If the carrier core 21 contains Mn ferrite, there is a tendency that as the content of Mn is higher, the saturation magnetization of the carrier core 21 is lower. If the carrier core 21 contains Mn—Mg ferrite, there is a tendency that as the content of Mg is higher, the saturation magnetization of the carrier core 21 is lower.

Here, if the saturation magnetization of the carrier in the developer currently in use stored in the developing device 3 is high, flowability of the developer currently in use tends to easily decrease, because of an influence of a magnetic field from the developing roller 31, and excessive discharge of the developer currently in use through the discharge path 34 is suppressed. For this reason, it is preferred that the saturation magnetization of the carrier in the developer currently in use be 75 emu/g or more. In other words, it is preferred that the saturation magnetization of the carrier core 21 be 75 emu/g or more. In this way, the mixing ratio between the toner and the carrier in the developer currently in use can be accurately detected, and hence the remaining amount of the developer currently in use in the developing device 3 is stabilized.

In addition, because the saturation magnetization of the carrier core 21 is 75 emu/g or more, carrier development can be suppressed. In other words, it is possible to suppress that the carrier particles 2 are adhered to the drum outer peripheral surface 5S.

The carrier particle 2 has a coat layer 22. The coat layer 22 coats the surface of the carrier core 21. For instance, the entire surface of the carrier core 21 is coated with the coat layer 22. The coat layer 22 contains silicone resin as a main component. In other words, a main component of the coat layer 22 in mass base is silicone resin. The constituent resin of the coat layer 22 may consist essentially of silicone resin, or in another embodiment, may contain other resins in addition to the silicone resin.

As a preferred example of the silicone resin, there is silicone resin having a methyl group, and epoxy modified silicone resin. An example of the silicone resin having a methyl group is a silicone resin that has a methyl group but does not have a phenyl group. Another example of the silicone resin having a methyl group is a silicone resin that has a methyl group and a phenyl group.

The coat layer 22 contains barium titanate particle. The contained amount of the barium titanate particles in the coat layer 22 is 2 pts. mass or more and 47 pts. mass or less, and preferably 3 pts. mass or more and 35 pts. mass or less, and more preferably 10 pts. mass or more and 25 pts. mass or less, with respect to 100 pts. mass of the silicone resin. The mean primary particle diameter of the barium titanate particle is 100 nm or more and 500 nm or less, and preferably 150 nm or more and 450 nm or less, and more preferably 250 nm or more and 350 nm or less.

The coat layer 22 contains carbon black particles. The carbon black particles correspond to an “electronic conductive agent”. The contained amount of the carbon black particles is 4 pts. mass or less with respect to 100 pts. mass of the silicone resin. The mean primary particle diameter of the carbon black particle is 10 nm or more and 80 nm or less, and preferably 30 nm or more and 45 nm or less.

Because the coat layer 22 contains the carbon black particles, charges move smoothly from the carrier particle 2 to the toner particle 1, and hence the toner particle 1 can be charged to a desired charge amount. In this way, an image having a desired image density and little fogging can be formed.

### <4. Maximum Electric Field Applied to Coat Layer>

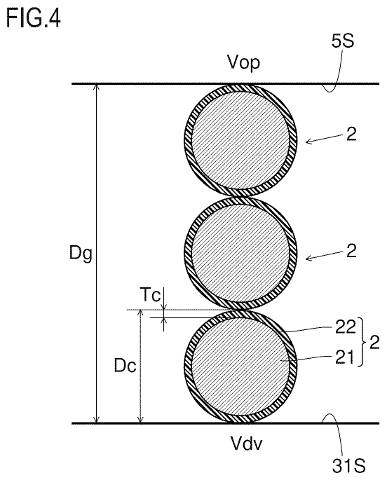

Hereinafter, with reference to FIG. 4, the maximum electric field applied to the coat layer 22 is described. FIG. 4 is a diagram schematically illustrating an area between the developer carrying surface 31S and the drum outer peripheral surface 5S. FIG. 4 schematically illustrates the carrier particles 2 of the magnetic brush carried on the developer carrying surface 31S.

The developer carrying surface 31S faces closely to the drum outer peripheral surface 5S. For this reason, the magnetic brush carried on the developer carrying surface 31S contacts the drum outer peripheral surface 5S. In other words, as illustrated in FIG. 4, an aggregate of the carrier particles 2 is inserted between a pair of pole plates.

Here, in this embodiment, when the maximum electric field applied to the coat layer 22 is expressed by the following equation (1), it is controlled so that the following inequality (2) is satisfied.

$$Emax = \vert Vop - Vdv \vert \times Dc / ( Tc \times 2 \times Dg ) \qquad ( 1 )$$

$$Emax \leq 4. \times 1 {0}^{7} \qquad ( 2 )$$

The parameters in the equation (1) and the inequality (2) are defined as follows.

In the above equation (1) and inequality (2), the maximum electric field applied to the coat layer 22 is Emax (V/m). Further, a surface potential of the drum outer peripheral surface 5S is Vop (V), the DC voltage applied to the developing roller 31 is Vdv (V), a particle size of the carrier particle 2 is Dc (m), a thickness of the coat layer 22 is Tc (m), and a development gap, which is a space between the developer carrying surface 31S and the drum outer peripheral surface 5S, is Dg (m). Note that in the following description, an absolute value of a difference between the surface potential Vop (V) and the DC voltage Vdv (V) (=|Vop-Vdv|) may be referred to as a development potential difference.

Here, dielectric breakdown of the carrier coat layer of the developer currently in use causes a color point or a white point on the image. Further, dielectric breakdown of the carrier coat layer of the developer currently in use causes carrier development.

Therefore, in this embodiment, the maximum electric field Emax applied to the coat layer 22 of the developer currently in use is controlled to satisfy the above inequality (2). In this way, dielectric breakdown of the coat layer 22 of the developer currently in use can be suppressed. As a result, occurrence of inconvenience due to the dielectric breakdown of the coat layer 22 of the developer currently in use (such as a color point or a white point on the image, or carrier development) can be suppressed.

In addition, in this embodiment, a constitutional material of the coat layer 22 of the developer currently in use is silicone resin. The silicone resin is resistant to the dielectric breakdown. In this way, the dielectric breakdown of the coat layer 22 of the developer currently in use can be suppressed more.

### <5. Confirmation Experiment>

Hereinafter, an experiment is described, which was performed for confirming effects of this embodiment (i.e., effects obtained by controlling the maximum electric field Emax applied to the coat layer 22 to satisfy the above inequality (2)). In the confirmation experiment, printing was actually performed, and states of printed images were checked.

### <5-1. Preparation of Toner>

The toner of the developer to be used for the confirmation experiment was prepared by the following method.

### <5-1-1. Synthesis of Amorphous Polyester Resin>

A reaction container, which is equipped with a thermometer (thermocouple), a dewatering conduit, a nitrogen gas introduction conduit, and a stirring device (stirring blade), was set in an oil bath. Then, 1,575 g of bisphenol A propylene oxide additive (BPA-PO), 163 g of bisphenol A ethylene oxide additive (BPA-EO), 377 g of fumaric acid, and 4 g of catalyst (dibutyltin oxide) were put into the reaction container.

After creating a nitrogen atmosphere in the reaction container, the temperature inside the reaction container was raised to 220 degrees Celsius while stirring the contents. Under the conditions of the nitrogen atmosphere and the temperature of 220 degrees Celsius, polymerization reaction of the contents in the reaction container was performed for 8 hours while removing by-product water. Next, the pressure inside the reaction container is reduced, and under the conditions of the reduced pressure atmosphere (pressure: 7,999 Pa) and the temperature of 220 degrees Celsius, the polymerization reaction of the contents in the reaction container was performed for more 1 hour. In addition, the temperature inside the reaction container was reduced to 210 degrees Celsius, and then 336 g of trimellitic anhydride was added into the reaction container. Then, under the conditions of the reduced pressure atmosphere (pressure: 7,999 Pa) and the temperature of 210 degrees Celsius, reaction of the contents in the reaction container was performed. After that, the reaction product was taken out from the reaction container and was cooled, and hence the amorphous polyester resin having the following physical properties was obtained. Note that the polyester resin obtained in this way did not clearly show its endothermic peak in the endothermic curve measured using a differential scanning calorimeter, and its clear melting point was not measured, and thus it was determined to be amorphous.
softening point (Tm): 100 degrees Celsius
glass transition point (Tg): 50 degrees Celsius
mass average molecular weight (Mw): 30,000
acid value: 15 mgKOH/g
hydroxyl value: 30 mgKOH/g

### <5-1-2. Preparation of Toner Mother Particles>

Using an FM mixer (“FM-10B” manufactured by Nippon Coke & Engineering Co., Ltd.), 100 pts. mass of binder resin, 4 pts. mass of coloring agent, 1 pts. mass of charge control agent, and 5 pts. mass of mold release agent were mixed, so that the mixture was obtained. As the binder resin, the amorphous polyester resin described above was used. As the coloring agent, copper phthalocyanine blue pigment (C.I. Pigment Blue 15:3) was used. As the charge control agent, quaternary ammonium salt (“BONTRON (registered trademark) P-51” manufactured by Orient Chemical Industries Co., Ltd.) was used. As the mold release agent, carnauba wax (“Special Carnauba Wax 1st” manufactured by S. KATO & CO.) was used.

Next, using a twin-screw extruder (“PCM-30 type” manufactured by Ikegai Co., Ltd.), the mixture was melted and kneaded, so that the melted and kneaded material was obtained. In addition, using a mechanical pulverizer (“Turbo Mill” manufactured by Freund-Turbo Corporation), the melted and kneaded material was pulverized, so that the pulverized material was obtained. Then, using a classifier (“Elbow Jet” manufactured by Nittetsu Mining Co., Ltd.), the pulverized material was classified. In this way, powder-like toner mother particles having a volume median diameter of 6.8 μm were obtained. Note that the volume median diameter (D₅₀) is a median diameter measured using a laser diffraction/scattering type particle size distribution measurement device (“LA-950” manufactured by HORIBA, Ltd.).

### <5-1-3. External Addition to Toner Mother Particles>

Using the FM mixer (“FM-10B” manufactured by Nippon Coke & Engineering Co., Ltd.), 100.0 pts. mass of the toner mother particle described above, 1.0 pts. mass of the silica particles (mean primary particle diameter: 20 nm), and 0.75 pts. mass of aluminum oxide particles (“AEROXIDE (registered trademark) Alu C805” manufactured by Nippon Aerosil Co., Ltd., BET specific surface area: 75 to 105 m²/g) were mixed for 5 minutes under the condition of 4,000 rpm, so that the mixture was obtained. Note that the mean primary particle diameter of the aluminum oxide particles is more than 300 nm. Then, using a sieve of 200 mesh (aperture of 75 μm), the mixture was sieved, and the toner shown in Table 1 was obtained. In the following description, the toner is shown by “T”.

TABLE 1
toner (T)

| mother | external additive particle | |
|---|---|---|
| particle | alumina particle | silica particle |

| pts. mass | pts. mass | pts. mass | diameter (nm) |
|---|---|---|---|
| 100 | 0.75 | 1 | 20 |

### <5-2. Preparation of Carrier>

The carrier of the developer to be used for the confirmation experiment was prepared by the following method.

### <5-2-1. Preparation of Coating Liquid>

The silicone resin solution, the barium titanate particles, the carbon black particles, and toluene were put into a stainless steel container. Then, using a homogenizer, the contents in the stainless steel container were mixed, so that the coating liquid was obtained. As the silicone resin solution, “KR-255” manufactured by Shin-Etsu Chemical Co., Ltd. (solid content: methylphenyl silicone resin, solid content concentration: 50 mass %) was used. As the barium titanate particle, “BT-01” manufactured by Sakai Chemical Industry Co., Ltd. (mean primary particle diameter: 304 nm) was used. As the carbon black particle, “Ketjenblack (registered trademark) EC300J” manufactured by LION SPECIALTY CHEMICALS CO., Ltd. (mean primary particle diameter: 39.5 nm), which is conductive carbon black, was used.

### <5-2-2. Preparation of Carrier Particles>

Using a fluid bed coating machine (“FD-MP-01 D type” manufactured by Powrex Corporation), 5,000 g of the carrier cores were allowed to flow, while the coating liquid was sprayed to the carrier cores. In this way, the carrier cores coated with the coating liquid were obtained. In this case, as the carrier cores, manganese ferrite cores (manufactured by DOWA IP Creation Co., Ltd., volume median diameter: 40 μm) were used. In addition, the amount of the coating liquid input to the fluid bed coating machine was adjusted, so that the mass of the coat layer (the layer obtained by heating the coating liquid) became as shown in Table 2 shown below, with respect to 1,000 g of the carrier core. Next, using an electric furnace, the carrier cores coated with the coating liquid were fired at 200 degrees Celsius for 1 hour, so that the coat layer was formed on the surface of the carrier core. In this way, the carrier particles were obtained.

Here, in the confirmation experiment, eight types of the carriers C1, C2, C3, C4, C5, C6, C7, and C8 were used. Characteristics of the carriers are shown in Table 2. In Table 2, for convenience's sake, each unit of the particle size Dc of the carrier particle and the coat layer thickness Tc is μm. In Table 2, the “coat layer (pts. mass)” means mass of the coat layer with respect to 100 pts. mass of carrier core.

TABLE 2
carrier

| | coat layer | Dc | Tc | CB amount | saturation |
|---|---|---|---|---|---|
| type | (pts. mass) | (μm) | (μm) | (pts. mass) | magnetization (emu/g) |
| C1 | 10 | 40 | 0.18 | 3 | 80 |
| C2 | 20 | 40 | 0.42 | 3 | 80 |
| C3 | 30 | 40 | 0.55 | 3 | 80 |
| C4 | 60 | 40 | 1.15 | 3 | 80 |
| C5 | 10 | 33 | 0.16 | 3 | 80 |
| C6 | 10 | 45 | 0.19 | 3 | 80 |
| C7 | 10 | 40 | 0.18 | 5 | 80 |
| C8 | 10 | 40 | 0.18 | 3 | 70 |

As shown in Table 2, the particle size Dc of each carrier particle of the carriers C1 to C4, C7, and C8 is 40 μm (or 4×10⁻⁵ m when using the above equation (1)). On the other hand, the particle size Dc of the carrier particle of the carrier C5 is 33 μm (or 3.3×10⁻⁵ m when using the above equation (1)). The particle size of the carrier particle of the carrier C6 is 45 μm (or 4.5×10−5 m when using the above equation (1)).

The thicknesses Tc of the coat layers of the carriers C1 to C6 are respectively 0.18 μm (or 1.8×10⁻⁷ m when using the above equation (1)), 0.42 μm (or 4.2×10⁻⁷ m when using the above equation (1)), 0.55 μm (or 5.5×10⁻⁷ m when using the above equation (1)), 1.15 μm (or 1.15×10⁻⁶ m when using the above equation (1)), 0.16 μm (or 1.6×10⁻⁷ m when using the above equation (1)), and 0.19 μm (or 1.9×10⁻⁷ m when using the above equation (1)).

In order to measure the coat layer thickness, a cross section of the carrier particle was photographed, using a transmission electron microscope TEM (“H-7100FA” manufactured by Hitachi High-Technologies Corporation). In addition, the TEM photographed image was analyzed using image analysis software (“WinROOF” manufactured by MITANI CORPORATION). Specifically, two straight lines, which are orthogonal at approximately the center of the cross section of the carrier particle, were drawn, and thicknesses at the four points where the two straight lines cross the coat layer were measured, and the arithmetic mean value of the thicknesses at the four points was calculated. Then, the mean value described above is obtained for each of ten carrier particles contained in the carrier to be measured, and an average value of the mean values described above of the ten carrier particles was calculated as the coat layer thickness of the carrier to be measured.

The contained amount of the carbon black particles in each coat layer of the carriers C1 to C6 and C8 is 3 pts. mass (i.e., 4 pts. mass or less), with respect to 100 pts. mass of the silicone resin. On the other hand, the contained amount of the carbon black particles in the coat layer of the carrier C7 is 5 pts. mass with respect to 100 pts. mass of the silicone resin.

The saturation magnetization of each carrier core of the carriers C1 to C7 is 80 emu/g (i.e., 75 emu/g or more). On the other hand, the saturation magnetization of the carrier core of the carrier C8 is 70 emu/g.

### <5-3. Evaluation (Check of Occurrence of Defect on Image)>

In order to check whether or not there is a defect such as a white point or a color point on the image, Experiments 1 to 8 were performed. As the evaluation machine, an image forming apparatus (Taskalfa3554ci) manufactured by KYOCERA Document Solutions Inc. was used. Then, images were actually formed using the developer.

Experimental conditions of the confirmation experiments 1 to 8 are shown in Table 3. In Table 3, for convenience's sake, a unit of the development gap Dg is μm.

TABLE 3

| experiment No. | carrier | Dg (μm) |
|---|---|---|
| experiment 1 | C1 | 350 |
| experiment 2 | C2 | 350 |
| experiment 3 | C3 | 350 |
| experiment 4 | C4 | 350 |
| experiment 5 | C1 | 250 |
| experiment 6 | C1 | 450 |
| experiment 7 | C5 | 350 |
| experiment 8 | C6 | 350 |

In the confirmation experiment 1, the developer in which the toner T and the carrier C1 are mixed was used. In addition, the development gap Dg was set to 350 μm (or 0.00035 m when using the above equation (1)).

In the confirmation experiment 2, the developer in which the toner T and the carrier C2 are mixed was used. In addition, the development gap Dg was set to 350 μm (or 0.00035 m when using the above equation (1)).

In the confirmation experiment 3, the developer in which the toner T and the carrier C3 are mixed was used. In addition, the development gap Dg was set to 350 μm (or 0.00035 m when using the above equation (1)).

In the confirmation experiment 4, the developer in which the toner T and the carrier C4 are mixed was used. In addition, the development gap Dg was set to 350 μm (or 0.00035 m when using the above equation (1)).

In the confirmation experiment 5, the developer in which the toner T and the carrier C1 are mixed was used. In addition, the development gap Dg was set to 250 μm (or 0.00025 m when using the above equation (1)).

In the confirmation experiment 6, the developer in which the toner T and the carrier C1 are mixed was used. In addition, the development gap Dg was set to 450 μm (or 0.00045 m when using the above equation (1)).

In the confirmation experiment 7, the developer in which the toner T and the carrier C5 are mixed was used. In addition, the development gap Dg was set to 350 μm (or 0.00035 m when using the above equation (1)).

In the confirmation experiment 8, the developer in which the toner T and the carrier C6 are mixed was used. In addition, the development gap Dg was set to 350 μm (or 0.00035 m when using the above equation (1)).

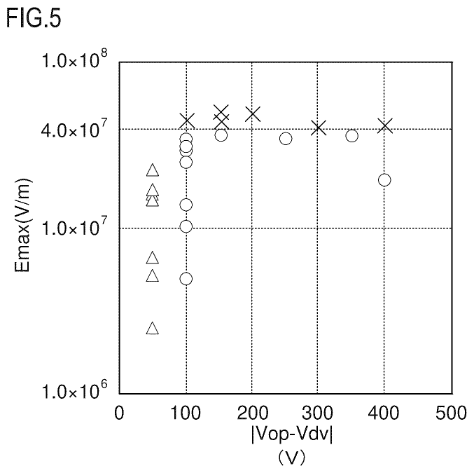

Further, in each of the confirmation experiments 1 to 8, the value of the development potential difference (the value corresponding to “|Vop−Vdv|” in the above equation (1)) was changed in 50 V steps from 50 V to 400 V, so as to form an image in each condition, and a defect (a white point or a color point) was checked on the image formed in each condition. A result of the check is shown in FIG. 5.

In FIG. 5, the horizontal axis is the development potential difference (the value corresponding to “|Vop−Vdv|” in the above equation (1)), and the vertical axis is the electric field applied to the coat layer (the value corresponding to “Emax” in the above equation (1)). Note that the vertical axis is a logarithmic scale.

In addition, in FIG. 5, a circle mark indicates that there was no defect on the image. On the other hand, an x mark indicates that there was a defect (at least one of a white point and a color point) on the image.

Here, FIG. 5 does not plot all of the experiment results. Specifically, when noting the confirmation experiment 3, there is no defect on the image in the range of the development potential difference from 100 V to 350 V, and there is a defect on the image at the development potential difference of 400 V, and hence circle marks are plotted only at 100 V and 350 V of the development potential difference, while an x mark is plotted at 400 V of the development potential difference. When noting the confirmation experiment 4, there was no defect on the image in the range of the development potential difference from 100 V to 400 V, and hence circle marks are plotted at only 100 V and 400 V of the development potential difference. Also for the other confirmation experiments, the same rule is used for plotting.

Note that there is an upper limit of the thickness of the coat layer that can be produced. Because of this upper limit, Emax has a lower limit of 4.5×10⁶ V/m.

In the experiment for checking occurrence of a defect on the image, as is clear from the result shown in FIG. 5, if the maximum electric field Emax applied to the coat layer is more than 4.0×10⁷ V/m, a defect such as a white point or a color point has occurred on the image. On the other hand, if the maximum electric field Emax applied to the coat layer is 4.0×10⁷ V/m or less, a defect such as a white point or a color point has not occurred on the image. The reason is considered that the dielectric breakdown of the carrier coat layer was suppressed. In other words, it can be said that if the above inequality (2) is satisfied, an inconvenience caused by the dielectric breakdown of the carrier coat layer can be suppressed.

Further, in the experiment for checking occurrence of a defect on the image, if the development potential difference is 50 V, an inconvenience that the density is not sufficient has occurred in each of Experiments 1 to 8. In FIG. 5, the result in the case where the development potential difference is 50 V is shown by a triangle mark.

Note that although the experiment was not performed, it is not preferred that the development potential difference be more than 400 V. If the development potential difference exceeds 400 V, an inconvenience that each lifetime of the developing roller and the photosensitive drum is shortened will occur.

Therefore, it can be said that it is preferred to satisfy the following inequality (3).

$$1 \; 00 \leq \vert Vop - Vdv \vert \leq 400 \qquad ( 3 )$$

### <5-4. Evaluation (Check of Stability of Image Density)>

In order to check stability of the image density, Experiments 9 to 11 were performed. As the evaluation machine, an image forming apparatus (Taskalfa3554ci) manufactured by KYOCERA Document Solutions Inc. was used. Then, images were actually formed on 300,000 sheets using the developer.

After printing, using a reflection densitometer (“SpectroEye (registered trademark)” manufactured by X-Rite Incorporated), the image density of each printed sheet (specifically, density of a solid patch image) was measured. In addition, it was determined how much the image density has changed from printing of the first sheet to printing of the 300,000th sheet (here, referred to as an ID change). Then, the evaluation was performed by the following criteria.
A: The ID change is ±0.2 or less.
B: The ID change is ±0.3 or less.

Note that the same image was printed on each sheet. Therefore, the sheets have the same image density, ideally.

Experimental conditions of the confirmation experiments 9 to 11 are shown in Table 4. In addition, results of the experiments are also shown in Table 4. Note that in Table 4, for convenience's sake, the unit of the development gap Dg is μm.

TABLE 4

| experiment No. | carrier | Dg (μm) | density stability |
|---|---|---|---|
| experiment 9 | C1 | 350 | A |
| experiment 10 | C7 | 350 | B |
| experiment 11 | C8 | 350 | B |

In the confirmation experiment 9, the developer in which the toner T and the carrier C1 are mixed was used. In addition, the development gap Dg was set to 350 μm (or 0.00035 m when using the above equation (1)).

In the confirmation experiment 10, the developer in which the toner T and the carrier C7 are mixed was used. In addition, the development gap Dg was set to 350 μm (or 0.00035 m when using the above equation (1)).

In the confirmation experiment 11, the developer in which the toner T and the carrier C8 are mixed was used. In addition, the development gap Dg was set to 350 μm (or 0.00035 m when using the above equation (1)).

In the result of the experiment, when the carrier C1 was used, the ID change was +0.2 or less. On the other hand, when the carrier C7 was used and when the carrier C8 was used, the ID change was more than +0.2 in each case (though the ID change was +0.3 or less).

Here, the contained amount of the carbon black particles in the coat layer of the carrier C7 is 5 pts. mass with respect to 100 pts. mass of the silicone resin, and is more than the contained amount of the carbon black particles of the carrier C1 (3 pts. mass with respect to 100 pts. mass of the silicone resin). For this reason, it is considered that the density was too high when the carrier C7 was used.

In addition, the saturation magnetization of the carrier core of the carrier C8 is 70 emu/g, and is less than the saturation magnetization of the carrier core of the carrier C1 (80 emu/g). For this reason, it is considered that stability of the remaining amount of the developer in the developing device was lowered when the carrier C8 was used.

Therefore, it can be said that it is preferred that the contained amount of the carbon black particles in the coat layer be 4 pts. mass or less with respect to 100 pts. mass of the silicone resin. In addition, it can be said that it is preferred that the saturation magnetization of the carrier core be 75 emu/g or more.

The embodiment disclosed this time is merely an example in every aspect, and should not be considered as a limitation. The scope of the present disclosure is defined not by the above description of the embodiment but by the claims, and further it includes all modifications within meaning and scope equivalent to the claims.

What is claimed is:

1. An image forming apparatus comprising:
a developer carrying member having a first surface, so as to carry a magnetic brush on the first surface, the magnetic brush containing toner and carrier in which carrier cores are coated with coat layers; and
an opposing member having a second surface located to face the first surface, the opposing member being applied with a development voltage including a DC voltage, so as to carry the toner moved from the magnetic brush, on the second surface, wherein
when a surface potential of the opposing member is Vop (V), the DC voltage is Vdv (V), a particle size of the carrier is Dc (m), a thickness of the coat layer is Tc (m), a space between the first surface and the second surface is Dg (m), and a maximum electric field applied to the coat layer is Emax (V/m), which is expressed by the following equation (1), then the following inequality (2) is satisfied.
$$Emax = \vert Vop - Vdv \vert \times Dc / ( Tc \times 2 \times Dg ) \qquad ( 1 )$$
$$Emax \leq 4. \times 1 {0}^{7} \qquad ( 2 )$$

2. The image forming apparatus according to claim 1, wherein the following inequality (3) is satisfied.
$$1 \; 00 \leq \vert Vop - Vdv \vert \leq 400 \qquad ( 3 )$$

3. The image forming apparatus according to claim 1, wherein the coat layer contains silicone resin as a main component.

4. The image forming apparatus according to claim 1, wherein
the coat layer contains an electronic conductive agent, and
a contained amount of the electronic conductive agent is 4 pts. mass or less with respect to 100 pts. mass of the silicone resin.

5. The image forming apparatus according to claim 1, wherein
the carrier core contains ferrite, and
a saturation magnetization of the carrier core is 75 emu/g or more.
